(19) United States
(12) Patent Application Publication
(10) Pub. No.: US 2018/0131245 A1
(43) Pub. Date: May 10, 2018

(54) EXTERNAL ROTOR MOTOR

(71) Applicant: INDUSTRIAL TECHNOLOGY RESEARCH INSTITUTE, Hsinchu (TW)

(72) Inventors: Chia-Hao HSU, Tainan City (TW); Yang-Guang LIU, Hsinchu County (TW); Shy-Her NIAN, Taoyuan City (TW); Yu-Choung CHANG, Hsinchu County (TW)

(73) Assignee: INDUSTRIAL TECHNOLOGY RESEARCH INSTITUTE, Hsinchu (TW)

(21) Appl. No.: 15/376,423

(22) Filed: Dec. 12, 2016

(30) Foreign Application Priority Data
Nov. 4, 2016 (TW) 105135897

(51) Int. Cl. H02K 1/27; H02K 1/16

(52) U.S. Cl. CPC H02K 1/2786; H02K 1/16

(57) ABSTRACT

An external rotor motor includes an inner stator and an external rotor. The inner stator includes a stator yoke and stator windings. The stator yoke has a first side and a second side opposite to each other. The first side and the second side are in an axial direction of the inner stator. The stator windings wound round the stator yoke. The external rotor includes a case and a magnet. The magnet is disposed on an inner side of the case, the stator yoke is surrounded by the magnet. The external rotor is rotatable to the inner stator. Two sides of the magnet opposite to each other respectively protrude from the first side and the second side of the stator yoke, and a center of the stator yoke and a center of the magnet are spaced apart by a distance in the axial direction of the inner stator.

### CROSS-REFERENCE TO RELATED APPLICATIONS

This non-provisional application claims priority under 35 U.S.C. § 119(a) on Patent Application No(s). 105135177 filed in Taiwan, R.O.C. on Oct. 28, 2016, the entire contents of which are hereby incorporated by reference.

### TECHNICAL FIELD

The disclosure relates to a motor, more particularly to an external rotor motor.

### BACKGROUND

A traditional permanent magnet motor is simple in structure, stable in operation, small in size, low in consumption and high in efficiency, and its shape and size are easy to be altered, so the traditional permanent magnet motor is widely used in many fields, such as aerospace, national defense, industry, agriculture, manufacturing and many staffs around us.

### SUMMARY

The present disclosure provides an external rotor motor in order to reduce Cogging torque and the wear on the bearing.

One embodiment of the disclosure provides an external rotor motor including an inner stator and an external rotor. The inner stator includes a stator yoke and a plurality of stator windings. The stator yoke has a first side and a second side which are opposite to each other. The first side and the second side are in an axial direction of the inner stator. The plurality of stator windings wound round the stator yoke. The external rotor includes a case and a magnet. The magnet is disposed on an inner side of the case, and the stator yoke is surrounded by at least part of the magnet. The external rotor is rotatable with respect to the inner stator. Two sides of the magnet opposite to each other respectively protrude from the first side and the second side of the stator yoke, and a center of the stator yoke and a center of the magnet are spaced apart by a distance in the axial direction of the inner stator.

### BRIEF DESCRIPTION OF THE DRAWINGS

The present invention will become better understood from the detailed description given hereinbelow and the accompanying drawings which are given by way of illustration only and thus are not limitative of the present invention and wherein:

FIG. 1 is a cross-sectional view of an external rotor motor according to a first embodiment of the disclosure;

FIG. 2 is a chart of displacement between a center of a stator yoke and a center of a magnet in FIG. 2 verse magnetostatic force;

FIG. 3 is a plan view of the stator yoke of an inner stator and magnets of an external rotor in FIG. 1;

FIG. 4 is a chart of pole/slot number combination verse Cogging torque;

FIG. 5 is a chart of Cogging torques of radially magnetized segments and sinusoidally magnetized Halbach cylinder; and

FIG. 6 is a cross-sectional view of an external rotor motor according to a second embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

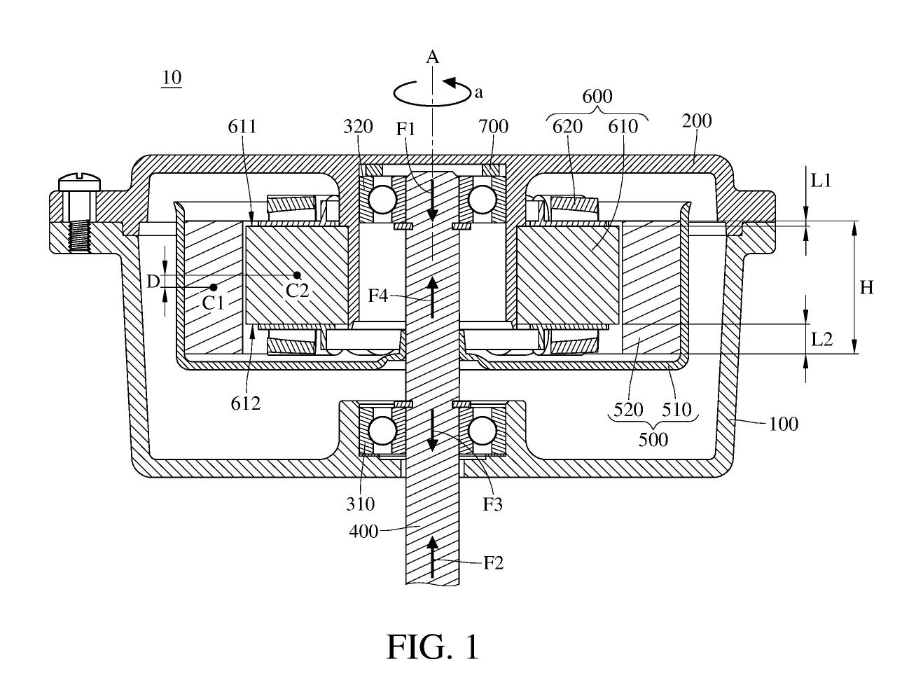

Please refer to FIG. 1. FIG. 1 is a cross-sectional view of an external rotor motor according to a first embodiment of the disclosure.

As shown in FIG. 1, an external rotor motor 10 is provided. The external rotor motor 10 includes a first cover 100, a second cover 200, two bearings 310 and 320, a shaft 400, an external rotor 500, an inner stator 600 and a gasket 700.

The second cover 200 and the first cover 100 are connected to each other. The second cover 200 and the first cover 100 together form an accommodating space S.

The two bearings 310 and 320 are located in the accommodating space S and respectively mounted on the first cover 100 and the second cover 200.

The shaft 400 is inserted over the bearings 310 and 320, and the shaft 400 protrudes from the first cover 100.

The external rotor 500 includes a case 510 and a magnet 520. The case 510 is located in the accommodating space S. The case 510 is fixed to the shaft 400 so that the case 510 and the shaft 400 are able to be rotated jointly, for example, in the direction of arrow a. The magnet 520 is disposed on an inner side of the case 510.

In this embodiment, there is only one magnet 520 which is ring-shaped, but the present disclosure is not limited thereto. In some embodiments, the motor may have plural magnets, and each magnet is arc-shaped. These arc-shaped magnets are disposed on the inner side of the case 510 to form a ring shaped magnet assembly.

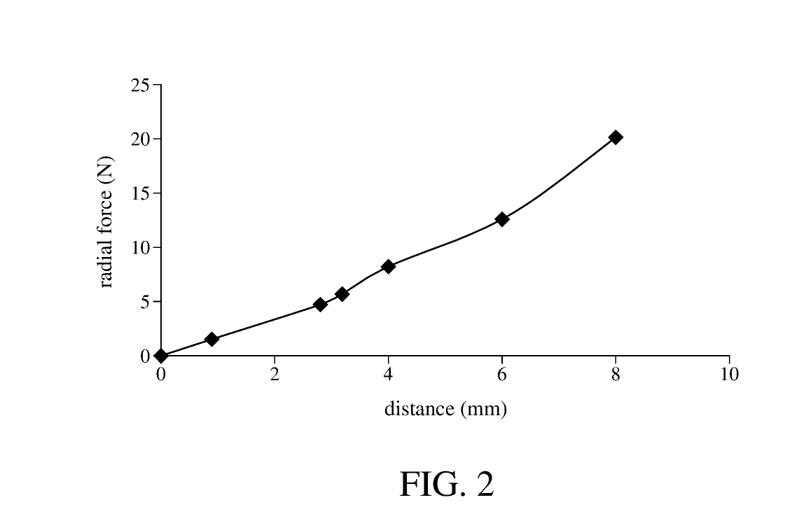

As shown in FIG. 1 and FIG. 2, the inner stator 600 includes a stator yoke 610 and a plurality of stator windings 620. The stator windings 620 are wound round the stator yoke 610. The stator yoke 610 is made of, for example, silicon steel plates. The stator yoke 610 has a first side 611 and a second side 612 which are arranged along an axial direction A of the inner stator 600. The stator yoke 610 is surrounded by the magnet 520 of the external rotor 500. The magnet 520 has a height H in the axial direction of the inner stator 600, and two opposite sides of the magnet 520 respectively protrude from the first side 611 and the second side 612 of the stator yoke 610. The magnet 520 protrudes a first length L1 from the first side 611 of the stator yoke 610, and the magnet 520 protrudes a second length L2 from the second side 612 of the stator yoke 610. In this embodiment, the first length L1 is different from the second length L2. Therefore, a center C2 of the stator yoke 610 and a center C1 of the magnet 520 are spaced apart from each other by a distance D in the axial direction of the inner stator 600.

The gasket 700 is, for example, wave-shaped. The gasket 700 is clamped between the second cover 200 and the bearing 320 mounted on the second cover 200.

In this embodiment, the gasket 700 provides a predetermined downward force F1 to the bearing 320. When the motor is operated, air in a flow field generates an upward force F2 to the shaft 400. There is a downward force of gravity F3 on the external rotor 500 and the shaft 400. The resultant force of F1, F2 and F3 is directed downward, which easily causing wear on the bearings 310 and 320 and reducing the performance of the motor. To prevent wear on the bearings 310, 320 and reduction of performance, in this embodiment, the magnet 520 of the external rotor 500 and the stator yoke 610 of the inner stator 600 are arranged with a deviation in the axial direction A; that is, the magnet 520 is asymmetric about a radial line passing through the center C2 of the stator yoke 610 while being orthogonal to the axial direction A. The arrangement of the magnet 520 and the stator yoke 610 generates an upward magnetostatic force F4. When a ratio of the distance D to the height H of the magnet 520 is greater than 0 and less than or equal to 1/3 (1:3), the resultant force along the axial direction is reduced from 20-25 newtons to 5-10 newtons, thereby reducing the wear on the bearings 310 and 320 and improving the performance of the external rotor motor 10. In addition, when the ratio of the distance D to the height H of the magnet 520 is greater than 1/3, the effect of the said magnetostatic force is largely reduced.

Please refer to FIG. 2. FIG. 2 is a chart of displacement between a center of a stator yoke and a center of a magnet in FIG. 2 verse magnetostatic force.

As shown in FIG. 2, the upward magnetostatic force F4 is increased with the incensement of the distance D between the center C2 of the stator yoke 610 and the center C1 of the magnet 520. The distance D may be altered according to the actual requirements.

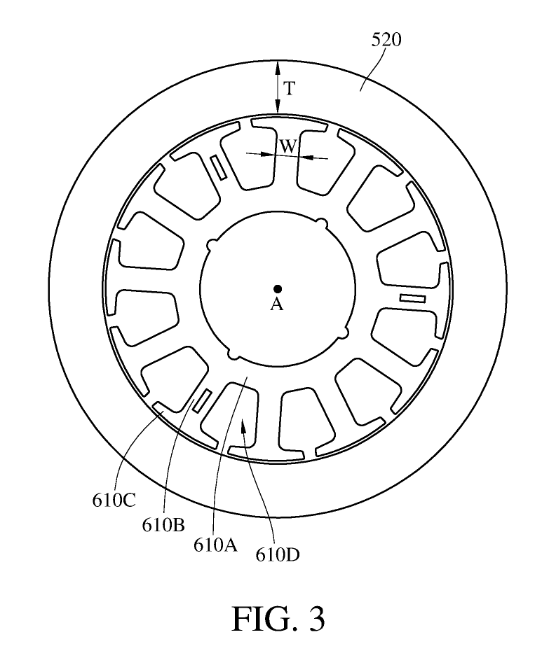

Please refer to FIG. 3. FIG. 3 is a plan view of the stator yoke of an inner stator and magnets of an external rotor in FIG. 1.

In this embodiment, the stator yoke 610 includes a yoke portion 610A, a plurality of teeth portions 610B and a plurality of boot portions 610C. The teeth portions 610B are connected to the yoke portion 610A, and the teeth portions 610B protrude radially and outwardly from the yoke portion 610A. In addition, the teeth portions 610B are separated from one another by stator slots 610D; that is, there is a stator slot 610D between every two of the teeth portions 610B that are adjacent to each other. The boot portions 610C are respectively connected to the teeth portions 610B. Each tooth portion 610B has a width W. The magnet 520 has a thickness T in a radial direction of the inner stator, and a ratio of the thickness T of the magnet to the width W of each tooth portion 610B is greater than or equal to 0.5 (0.5:1) and less than or equal to 2.5 (2.5:1). When the ratio of the thickness T to the width W of each tooth portion is less than 0.5, the tooth portion 610B is too wide and uses too much material of the silicon steel plate, and magnetic force is decreased with the incensement of the width of each tooth portion. As a result, the performance of the motor is decreased. When the ratio of the thickness T to the width W of each tooth portion 610B is greater than 2.5, the magnet is too thick, and the magnetic saturation occurs. As a result, the magnetic force is reduced when passing through the stator yoke, waste heat is increased, and the lifespan of the motor is reduced.

In addition, in this embodiment, a ratio of the number of poles of the external rotor 500 to the number of slots of the inner stator 600 is 7X:6Y, the ratio called pole/slot number combination, X is an even number greater than 1, and Y is a natural number greater than 1. The number of slots of the inner stator 600 is the number of the stator slots 610D. The number of poles of the external rotor 500 is able to be detected by a magnetic-field measurement apparatus. In this embodiment, the number of poles of the external rotor 500 is 14, and the number of slots of the inner rotor 600 is 12, but the present disclosure is not limited thereto. In some embodiments, the number of poles of the external rotor may be 14, and the number of slots of the inner rotor may be 18. Or, the number of poles of the external rotor may be 14, and the number of slots of the inner rotor may be 6.

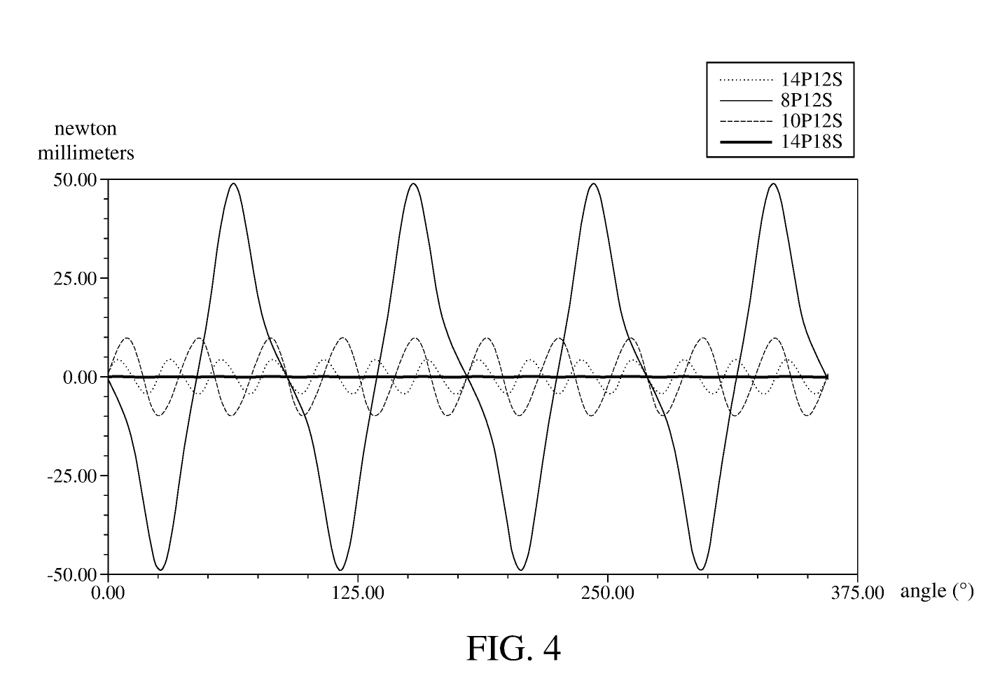

Please refer to FIG. 4. FIG. 4 is a chart of pole/slot number combination verse Cogging torque.

As shown in FIG. 4, when the slot/pole number combination is 8P (number of poles)/12S (number of slots), the Cogging torque is the greatest. When the pole/slot number combination is 10P (number of poles)/12S (number of slots), the Cogging torque is smaller. When the pole/slot number combination is 14P (number of poles)/12S (number of slots), the Cogging torque is much smaller. When the pole/slot number combination is 14P (number of poles)/18S (number of slots), the Cogging torque is the smallest being nearly zero. Accordingly, the Cogging torque is able to be improved by changing the pole/slot number combination, and thereby improving the performance of the motor.

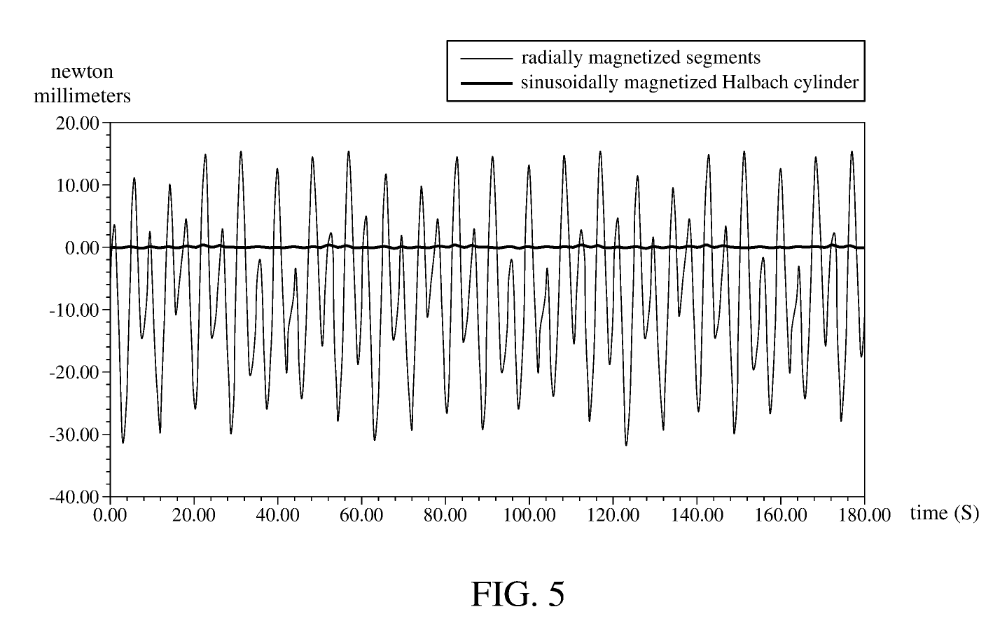

Please refer to FIG. 5. FIG. 5 is a chart of Cogging torques of radially magnetized segments and sinusoidally magnetized Halbach cylinder.

As shown in FIG. 5, the Cogging torque of the radially magnetized segments is largely greater than the Cogging torque of the sinusoidally magnetized Halbach cylinder. Thus, the Cogging torque of the magnet of the disclosure is able to be decreased by using the sinusoidally magnetized Halbach cylinder.

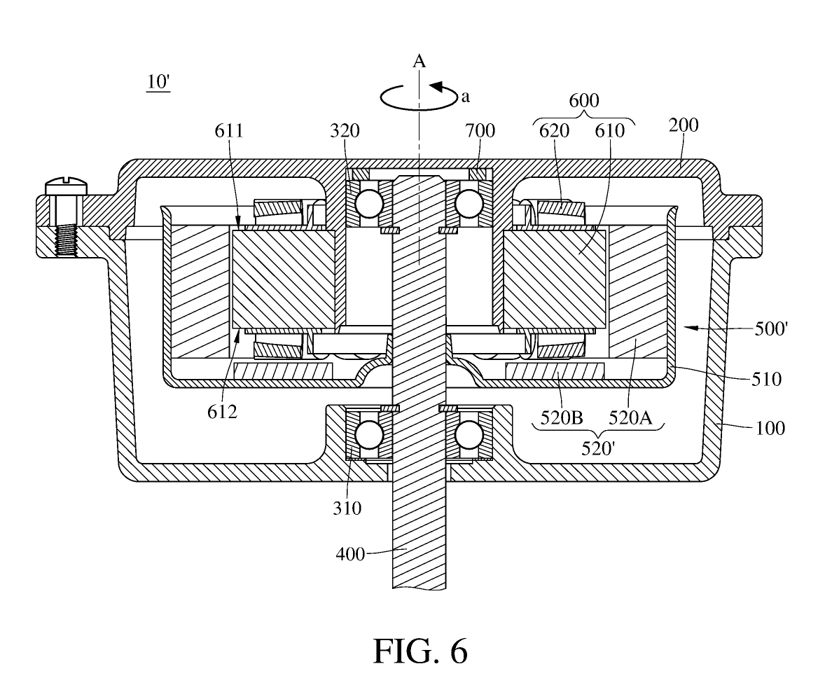

Please refer to FIG. 6. FIG. 6 is a cross-sectional view of an external rotor motor according to a second embodiment of the disclosure. In this embodiment, an external rotor motor 10′ is provided, but the external rotor motor 10′ is similar to the aforementioned external rotor motor 10, so only the differences therebetween are described in the following paragraphs.

The external rotor motor 10′ includes a magnet 520′. The magnet 520′ includes a plurality of first magnet units 520A and a plurality of second magnet units 520B. The stator yoke 610 is surrounded by the first magnet unit 520A, The first magnet unit 520A and the second magnet unit 520B are respectively located on adjacent sides of the stator yoke 610. For example, the first magnet unit 520A is located at the outer side of the stator yoke 610, and the second magnet unit 520B is located at the bottom side of the stator yoke 610 so that an upwardly force similar to the aforementioned magnetostatic force F4 is generated.

According to the external rotor motor as discussed above, the center of the stator yoke and the center of the magnet are spaced apart by a distance in the axial direction of the inner stator, that is, the magnet of the external rotor and the stator yoke of the inner stator are asymmetric in the axial direction so that an upward magnetostatic force is generated. Therefore, the resultant force along the axial direction is reduced from 20-25 newtons to 5-10 newtons, thereby reducing the wear on the bearings and improving the performance of the external rotor motor.

In addition, Cogging torque of the motor is able to be reduced since the stator yoke has the sinusoidally magnetized Halbach cylinder.

Furthermore, the ratio of the number of poles of the external rotor to the number of slots of the inner stator is 7X:6Y (i.e. the pole/slot number combination), so Cogging torque is able to be reduced, and thereby improving the performance of the motor.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. An external rotor motor, comprising:
an inner stator comprising a stator yoke and a plurality of stator windings, the stator yoke having a first side and a second side which are opposite to each other, the first side and the second side being in an axial direction of the inner stator, and the plurality of stator windings wound round the stator yoke; and
an external rotor comprising a case and a magnet, the magnet disposed on an inner side of the case, and the stator yoke surrounded by at least part of the magnet, and the external rotor being rotatable with respect to the inner stator;
wherein, two sides of the magnet opposite to each other respectively protrude from the first side and the second side of the stator yoke, and a center of the stator yoke and a center of the magnet are spaced apart by a distance in the axial direction of the inner stator.

2. The external rotor motor according to claim 1, wherein the magnet has a height in the axial direction of the inner stator, and a ratio of the distance to the height is greater than 0 and less than or equal to 1/3.

3. The external rotor motor according to claim 1, wherein the magnet protrudes from the first side of the stator yoke at a first length, the magnet protrudes from the second side of the stator yoke at a second length, and the first length is different from the second length.

4. The external rotor motor according to claim 1, wherein the magnet comprises a first magnet unit and a second magnet unit, the stator yoke is surrounded by the first magnet unit, and the first magnet unit and the second magnet unit are respectively located at adjacent sides of the stator yoke.

5. The external rotor motor according to claim 1, wherein a ratio of a number of poles of the external rotor to a number of slots of the inner stator is 7X:6Y, X is an even number greater than 1, and Y is a natural number greater than 1.

6. The external rotor motor according to claim 5, wherein the number of poles of the external rotor is 14, and the number of slots of the inner rotor is 12.

7. The external rotor motor according to claim 5, wherein the number of poles of the external rotor is 14, and the number of slots of the inner rotor is 18.

8. The external rotor motor according to claim 5, wherein the number of poles of the external rotor is 14, and the number of slots of the inner rotor is 6.

9. The external rotor motor according to claim 1, wherein the magnet has a thickness in a radial direction of the inner stator, the stator yoke comprises a yoke portion, a plurality of teeth portions and a plurality of boot portions, the plurality of teeth portions are connected to the yoke portion, the plurality of teeth portions protrude radially and outwardly from the yoke portion, the plurality of teeth portions are separated from one another by a plurality of stator slots, the plurality of boot portions are respectively connected to the plurality of teeth portions, and a ratio of the thickness of the magnet to a width of each of the plurality of teeth portions is greater than or equal to 0.5 and less than or equal to 2.5.

10. The external rotor motor according to claim 1, further comprising a first cover, a second cover, two bearings, a shaft and a gasket, the second cover and the first cover being connected to each other, the two bearings respectively disposed on the first cover and the second cover, the shaft inserted over the two bearings, the shaft protruding from the first cover, the case of the external rotor fixed to the shaft, the case and the shaft jointly rotatable, the gasket clamped between the second cover and the bearing mounted on the second cover.
